(19) United States
(12) Patent Application Publication
(10) Pub. No.: US 2010/0202132 A1
(43) Pub. Date: Aug. 12, 2010

(54) BLACKLIGHTING DEVICE AND DISPLAY DEVICE PROVIDED WITH THE SAME

(76) Inventor: Ryuhei Kishimoto, Osaka (JP)

Correspondence Address: HARNESS, DICKEY & PIERCE, P.L.C., P.O. BOX 8910, RESTON, VA, 20195, US

(21) Appl. No.: 12/733,616

(22) PCT Filed: Sep. 9, 2008
(86) PCT No.: PCT/JP2008/066243

§ 371 Date: Mar. 11, 2010

(30) Foreign Application Priority Data
Sep. 12, 2007 (JP) 2007-236990

(51) Int. Cl. G02F 1/13357

(52) U.S. Cl. 362/97.1

(57) ABSTRACT

A pseudo U-character tube system backlighting device is configured to reduce the number of inverter transformers without imposing strict limits to mutual insulation between neighboring inverter transformers. A backlighting device, in at least one embodiment, is provided with a plurality of lamps, an inverter circuit, and light emitting surfaces, wherein the plurality of lamps with which first electrodes of a first inverter transformer are connected, are continuously arranged to form a first lamp arrangement group, the plurality of lamps, with which first electrodes of a second inverter transformer are connected, are continuously arranged to form a second lamp arrangement group, and the second electrodes of the lamps belonging to the first lamp arrangement group are connected with either of the second electrodes of the lamps belonging to the second lamp arrangement group.

### TECHNICAL FIELD

The present invention relates to a backlight device including a plurality of lamps that are driven by an inverter circuit and a display device using the backlight device.

### BACKGROUND ART

In recent years, liquid crystal display devices with such advantages as low power-consuming, slim and lightweight have been used widely as display devices for television sets. Liquid crystal panels as display elements used for the display portion of liquid crystal display devices are so-called non-luminous display elements that do not emit light by themselves. Therefore, normally, a light source called a backlight device is provided on the back of a liquid crystal panel, and images are displayed by controlling the transmittance of light from the backlight device through the liquid crystal.

Here, as backlights for liquid crystal display devices, surface emitting backlight devices that permit uniform brightness and color in the entire image display region of liquid crystal panels are required. As the backlight devices that satisfy such requirements, two types of backlight devices, direct type and edge-light type, have been known.

A direct type is a surface emitting light source achieved by arranging a plurality of fluorescent tubes on the back of a liquid crystal panel as a backlight source and making the brightness of light that is irradiated by the fluorescent tubes uniform through a diffusion plate, a lens sheet, etc. On the other hand, an edge-light type (also referred to as a side-light type) is a surface emitting light source achieved by reflecting, over and over again, within a light guiding plate having a shape corresponding to the image display region of a liquid crystal panel, light from the fluorescent tubes incident to the light guiding plate from a side surface of the light guiding plate to propagate it and eventually emitting the light to the liquid crystal panel side.

In liquid crystal display devices including a liquid crystal panel with a size of 20 inches or more, such as those used for television sets, generally, the direct type backlight devices are used because it is easier to increase their brightness and size than those of the edge-light type. Furthermore, the direct type backlight devices have a hollow structure and therefore are lightweight even when their size is increased. In this regard, the direct type backlight devices are suited for increasing the brightness and the size.

As fluorescent tubes used in such direct type backlight devices, cold cathode fluorescent lamps (CCFLs) have been utilized in many cases, and as circuits for lighting and driving the cold cathode fluorescent lamps, inverter circuits that obtain operating voltages by boosting, with the use of inverter transformers, commercial alternating voltages as input voltages have been used.

FIGS. 6A and 6B are schematic block diagrams showing connections between inverter circuits and cold cathode fluorescent lamps as the light source in conventional backlight devices.

FIG. 6A shows an inverter drive type called the inverter with floating type (Hot-Hot type) in which voltages are applied, from inverter circuits 30 and 30′, to two electrodes placed respectively at both ends of each of cold cathode fluorescent lamps 20a to 20h, in other words, to both first electrodes 20a1 to 20h1 and second electrodes 20a2 to 20h2 of the cold cathode fluorescent lamps 20a to 20h. In this type, voltages can be supplied to the cold cathode fluorescent lamps in a stable manner. For this reason, this type is used in backlight devices applied to large liquid crystal display devices with a size of 40 inches or more where an increase in the length of the cold cathode fluorescent lamps is inevitable.

In contrast, FIG. 6B shows an inverter drive type called the inverter with the earthed type (Hot-Cold type) in which voltages are applied, from the inverter circuit 30, only to the electrodes of the cold cathode fluorescent lamps 20a to 20h on one side, in other words, only to the first electrodes 20a1 to 20h1 of the cold cathode fluorescent lamps 20a to 20h, and the second electrodes 20a2 to 20h2 as the electrodes of the cold cathode fluorescent lamps on the other side are grounded. In the inverter with the earthed type, since it is not necessary to apply voltages to the second electrodes as the electrodes of the cold cathode fluorescent lamps on the other side, the number of the inverter circuits can be reduced. Therefore, it is possible to reduce the size of the backlight device. In terms of the stability of voltages that are applied to the cold cathode fluorescent lamps, however, application of this type to backlight devices used in large liquid crystal display devices with a size of, for example, 40 inches or more is difficult.

There is a pseudo U-shaped tube method as a method that enables application of driving voltages to cold cathode fluorescent lamps in a stable and simple manner while solving the various problems mentioned above. FIG. 7 is a schematic block diagram showing a state of voltage application using the pseudo U-shaped tube method.

As shown in FIG. 7, in the pseudo U-shaped tube method, similarly to the inverter with the earthed type shown in FIG. 6B, voltages are applied, from the inverter circuit 30, to the electrodes of the cold cathode fluorescent lamps 20a to 20h on one side, in other words, only to the first electrodes 20a1 to 20h1 of the respective cold cathode fluorescent lamps. Every two adjacent cold cathode fluorescent lamps, 20a and 20b, 20c and 20d, . . . are connected to each other by the second electrodes 20a2 and 20b2 . . . 20g2 and 20h2 as the other electrodes not in connection with the inverter circuit 30 being connected to each other.

Specifically, as shown in FIG. 7, the second electrode 20a2 of the cold cathode fluorescent lamp 20a and the second electrode 20b2 of the cold cathode fluorescent lamp 20b are connected to each other through a connection line 21a, and the second electrode 20c2 of the cold cathode fluorescent lamp 20c and the second electrode 20d2 of the cold cathode fluorescent lamp 20d are connected to each other through a connection line 21b. And in the similar manner, the second electrodes 20e2 and 20f2 are connected to each other through a connection line 21c, and the second electrodes 20g2 and 20h2 are connected to each other through a connection line 21d.

By connecting two cold cathode fluorescent lamps, for example, 20a and 20b to each other in series, these two cold cathode fluorescent lamps 20a and 20b are arranged as one U-shaped tube when seen from the inverter circuit 30 side and operate as one U-shaped tube. For this reason, the method is called the “pseudo” U-shaped tube method. FIG. 8 of Patent document 1 shows that cold cathode even though the method is not directly applied to a direct type backlight device.
Patent document 1: JP 2002-231034A

### DISCLOSURE OF INVENTION

### Problem to be Solved by the Invention

When using such a pseudo U-shaped tube method, connections of cold cathode fluorescent lamps can be achieved by only electrically connecting the electrodes of the cold cathode fluorescent lamps not in connection with the inverter circuit to each other, and this can be achieved by a simple configuration of only connecting the connectors to sockets that are physically holding the ends of the cold cathode fluorescent lamps. Accordingly, this method has an advantage over the inverter with the earthed type which requires grounding in that the electric configuration can be simplified.

On the other hand, when applying driving voltages to cold cathode fluorescent lamps using the pseudo U-shaped tube method, discharge paths having a length substantially equivalent to two cold cathode fluorescent lamps, in other words, discharge paths having a length as twice as large as the width of the backlight device are formed. To ensure the discharge paths with such a large length, it is necessary to maximize the difference between voltages applied to the electrodes at the both ends, so that voltages having opposite phases in waveform need to be applied to the both ends of the two cold cathode fluorescent lamps that are connected to each other in series. Here, opposite phases refer to phases of alternating voltages shifted from each other by “n”, and their relationship corresponds to the relationship between a sine wave and a cosine wave of waveforms of normal alternating voltages.

Also in the conventional pseudo U-shaped tube method, since every two adjacent cold cathode fluorescent lamps form a “U-shaped tube”, the both ends of the two cold cathode fluorescent lamps that are connected to each other in series correspond to adjacent connection terminals through which the cold cathode fluorescent lamps are connected to the inverter circuit.

Therefore, as shown in FIG. 7, as inverter transformers provided at the terminal portions where voltages are applied to the cold cathode fluorescent lamps 20a to 20h from the inverter circuit 30, as the waveforms in the drawing indicate, transformers having opposite phases to each other need to be placed alternately as adjacent inverter transformers T1 and T2, T3 and T4 . . . , for example.

Therefore, in a backlight device using this conventional pseudo U-shaped tube method, the same number of inverter transformers as that of the cold cathode fluorescent lamps is required. Furthermore, since the transformers having opposite phases as well as the output terminals need to be placed at positions that are dose to each other in distance, the voltage difference equivalent to as twice as large as the voltages applied to the cold cathode fluorescent lamps always develops between these adjacent circuit elements. Therefore, they certainly need to be insulated electrically.

With the foregoing in mind, it is an object of the present invention to achieve a backlight device in which driving voltages are applied to lamps used as the light source using a pseudo U-shaped tube method in a state where the number of required inverter transformers is reduced and severe restrictions are not applied to the insulation between adjacent inverter transformers, and a display device using such a backlight device.

### Means for Solving Problem

In order to solve the above objective, the backlight device according to the present invention is a backlight device including a plurality of lamps arranged in series, an inverter circuit for generating, from input voltages, voltages for driving the lamps and a light-emitting surface for emitting light from the lamps towards outside. The lamps each include first and second electrodes at both ends thereof in a longitudinal direction, the inverter circuit includes first and second inverter transformers that have opposite phases to each other, among the lamps, those with the first electrodes being connected to the first inverter transformer are arranged in sequence and form a first multi lamp array group, and those with the first electrodes being connected to the second inverter transformer are arranged in sequence and form a second multi lamp array group, and the second electrodes of the lamps of the first multi lamp array group are connected to any of the second electrodes of the lamps of the second multi lamp array group.

The display device according to the present invention is a display device including; a display portion; and the backlight device according to the present invention. The display portion is irradiated with light from the backlight device.

### Effect of the Invention

According to the present invention, it is possible to simplify the configuration of the inverter circuit, such as a reduction in the number of required inverter transformers, while using, as a method of applying voltages to the lamps as the light source, the pseudo U-shaped tube method that permits simplification of the circuit configuration and the electric configuration of terminal portions of the lamps. Therefore, it is possible to achieve a backlight device that can be produced at low cost and can be reduced in its size and the display device using the backlight device.

### BRIEF DESCRIPTION OF DRAWINGS

FIG. 1 is an exploded perspective view showing a schematic configuration of a liquid crystal display device according to one embodiment of the present invention.

FIG. 2 is a schematic diagram showing a connection state of lamps and an inverter circuit in a backlight device of the liquid crystal display device according to one embodiment of the present invention.

FIGS. 3A and 3B are schematic diagrams showing a configuration in which outputs from inverter transformers are distributed to the plurality of lamps in the backlight device according to Embodiment 1 of the present invention. FIGS. 3A and 3B show a case where coils are used as distributors and a case where capacitors are used as distributors, respectively.

FIG. 4 is a schematic diagram showing other connection status of the lamps and the inverter circuit in the backlight device of the liquid crystal display device according to one embodiment of the present invention.

FIG. 5 is a schematic diagram showing a connection status of lamps and an inverter circuit in a backlight device of a liquid crystal display device according to Embodiment 2 of the present invention.

FIGS. 6A and 6B are diagrams showing methods of applying driving voltages to cold cathode fluorescent lamps. FIG. 6A shows the inverter with the earthed type and FIG. 6B shows the inverter with floating type.

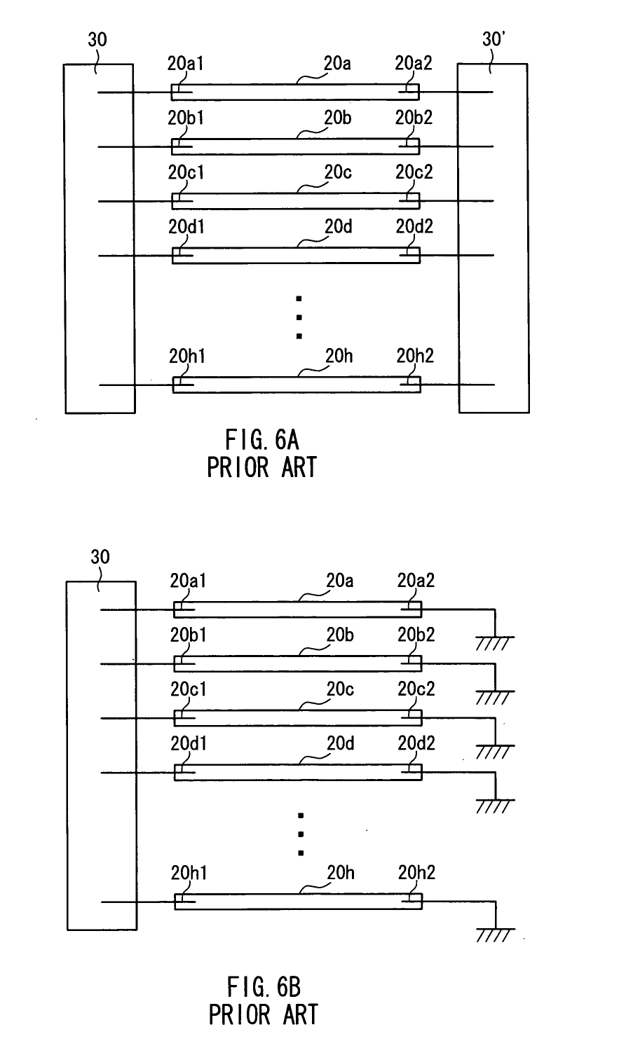

FIG. 7 is a schematic diagram showing a connection status of lamps and inverter circuits using a conventional pseudo U-shaped tube method.

### DESCRIPTION OF THE INVENTION

The backlight device according to the present invention is a backlight device including a plurality of lamps arranged in series, an inverter circuit for generating, from input voltages, voltages for driving the lamps and a light-emitting surface for emitting light from the lamps towards outside. The lamps each include first and second electrodes at both ends thereof in a longitudinal direction, the inverter circuit includes first and second inverter transformers that have opposite phases to each other, among the lamps, those with the first electrodes being connected to the first inverter transformer are arranged in sequence and form a first multi lamp array group, and those with the first electrodes being connected to the second inverter transformer are arranged in sequence and form a second multi lamp array group, and the second electrodes of the lamps of the first multi lamp array group are connected to any of the second electrodes of the lamps of the second multi lamp array group.

By configuring the backlight device in this way, the waveform phases of voltages that are supplied to the lamps of one multi lamp array group become the same, so that the common inverter transformer can be used. As a result, the configuration of the inverter circuit can be simplified.

Further, at least the number of the first multi lamp array group or the second multi lamp array group formed in the backlight device may be more than one.

By configuring the backlight device in this way, the multi lamp array groups can be formed per corresponding inverter transformer. Thus, it is possible to deal with a case where the backlight device has a large number of lamps due to the display element of the display device having a large size.

And in this case, it is particularly preferable that two or more of the first multi lamp array groups and of the second multi lamp array groups are arranged in alternate order.

Furthermore, it is preferable that the lamps are cold cathode fluorescent lamps and the cold cathode fluorescent lamps are straight fluorescent tubes that are circular in cross section. By so doing, the backlight device for a display device can be achieved with the use of cold cathode fluorescent lamps as the most common lamps.

Further, the backlight device preferably includes a coil for distributing an output of the inverter transformers to the plurality of lamps of the multi lamp array groups or a capacitor for distributing an output of the inverter transformers to the plurality of lamps of the multi lamp array groups. By so doing, outputs from the inverter transformers can be supply to the plurality of lamps in stable manner.

The display device according to the present invention is a display device including: a display portion; and the backlight device according to the present invention. The display portion is irradiated with light from the backlight device.

By configuring the display device in this way, it is possible to achieve a display device that makes full use of the features of the backlight device of the present invention, such as allowing cost and size reductions.

Hereinafter, preferred embodiments of the backlight device and display device of the present invention will be described with reference to the drawings. In the following, a case where the display device of the present invention is applied to a television receiver including a transmissive liquid crystal display element as its display portion will be described as an example. However, the description does not limit the targets to which the present invention can be applied. For example, a semi-transmissive liquid crystal display element can be used as the display portion of the present invention. Further, display elements that can be used for the display portion are not limited to liquid crystal panels, and it is possible to use other types of display elements that display images using irradiation light from the backlight device as the light source. Furthermore, the use of the display device of the present invention is not limited only to a television receiver.

### Embodiment 1

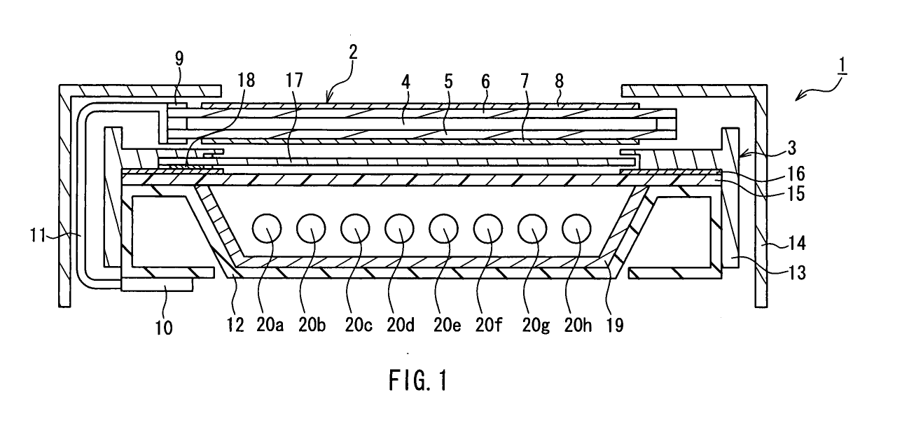

FIG. 1 is a schematic cross-sectional view for explaining a backlight device and a liquid crystal display device including the backlight device according to Embodiment 1 of the present invention. As shown in FIG. 1, a liquid crystal display device 1 of the present embodiment includes: a liquid crystal panel 2 (display portion) placed such that its visual recognition side (display surface side) faces the topside in FIG. 1; and a backlight device 3 for irradiating the liquid crystal panel 2 with planer light placed on the non-display surface side (bottom side in the drawing) of the liquid crystal panel 2.

The liquid crystal panel 2 includes a liquid crystal layer 4, a pair of transparent substrates 5 and 6 between which the liquid crystal layer 4 is interposed and polarizers 7 and 8 provided respectively on the outer surfaces of the transparent substrates 5 and 6. Further, the liquid crystal panel 2 includes a driver 9 for driving the liquid crystal panel 2 and a driving circuit 10 connected to the driver 9 through a flexible printed board 11.

The liquid crystal panel 2 is an active matrix liquid crystal panel and the liquid crystal layer 4 can be driven by the pixel by supplying scanning signals and data signals respectively to scanning lines and data lines arranged in a matrix. That is, when TFTs (switching elements) provided in the vicinity of points of intersection of the scanning lines and the data lines are turned on by the signals supplied to the scanning lines, the alignment state of liquid crystal molecular in each of pixels changes in accordance with the potential levels of the data signals supplied to pixel electrodes from the data lines, and as a result, grey scale in accordance with the data signals is achieved. In other words, on the liquid crystal panel 2, desired images are displayed by the liquid crystal layer 4 modulating the polarization state of light that entered therein from the backlight device 3 through the polarizer 7 and controlling the amount of the light that passes through the polarizer 8.

The backlight device 3 includes a bottomed case 12 whose upper side in the drawing is opened, and a frame 13 placed on the case 12 on the liquid crystal panel 2 side. Further, the case 12 and the frame 13 are made of metal or a synthetic resin and are interposed between L-shape cross-section bezels 14 while the liquid crystal panel 2 is placed above the frame 13. Thus, the backlight device 3 is combined with the liquid crystal panel 2 and is integrated therewith as the transmissive liquid crystal display device 1 in which illumination light from the backlight device 3 enters the liquid crystal panel 2.

The backlight device 3 further includes a diffusion plate 15 placed so as to cover the opening of the case 12, an optical sheet 17 placed above the diffusion plate 15 on the liquid crystal panel 2 side and a reflecting sheet 19 provided on the inner surface of the case 12. Further, the backlight device 3 includes cold cathode fluorescent lamps (CCFLs) 20 as light source lamps, and they are provided above the reflecting sheet 19 at a predetermined pitch such that their longitudinal direction becomes substantially the same. Light from these cold cathode fluorescent lamps 20 (20a to 20h) is outputted towards the liquid crystal panel 2 as planer light. Although a configuration in which the eight cold cathode fluorescent lamps, 20a, 20b, 20c, 20d, 20e, 20f 20g and 20h, are provided is shown in FIG. 1 for the sake of brevity, the number of the cold cathode fluorescent lamps is not limited to eight. For example, in a liquid crystal display device for a television set whose screen size is 32 inches, 14 cold cathode fluorescent lamps are arranged in parallel.

The diffusion plate 15 is made of, for example, a synthetic resin or a glass material with a thickness of about 2 mm, and diffuses light (including light reflected by the reflecting sheet 19) from the cold cathode fluorescent lamps 20a to 20h and outputs the light to the optical sheet 17 side. Further, the four sides of the diffusion plate 15 are mounted on a frame-shaped surface provided on the upper side of the case 12, so that the diffusion plate 15 is incorporated in the backlight device 3 while being interposed between the frame-shaped surface of the case 12 and the inner surface of the frame 13 via an elastically-deformable pressure member 16. Furthermore, the diffusion plate 15 is supported, roughly at its center, by a transparent support member (not shown) provided on the reflecting sheet 19, so that it is prevented from being bent towards the inner side of the case 12.

Further, the diffusion plate 15 is held movably between the case 12 and the pressure member 16. Thus, even when expansion (plastic) deformation occurs to the diffusion plate 15 due to an influence of heat, such as heat generated by the cold cathode fluorescent lamps 20a to 20h or an increase in the temperature inside the case 12, the plastic deformation is absorbed by the pressure member 16 deforming elastically, whereby a decrease in the diffusibility of light from the cold cathode fluorescent lamps 20a to 20h is minimized. Further, it is preferable to use the diffusion plate 15 made of a glass material having high heat resistance than of a synthetic resin because warpage, yellowing, thermal deformation, and the like caused by the above influence of heat are unlikely to occur.

The optical sheet 17 includes a light-gathering sheet formed of, for example, a synthetic resin film with a thickness of about 0.5 mm, and is configured to increase the brightness of illumination light from the backlight device 3 to the liquid crystal panel 2. Further, optical sheet materials, such as a prism sheet, a diffusion sheet and a polarization sheet for improving the display quality on the display surface of the liquid crystal panel 2 are laminated on the optical sheet 17 as needed. And the optical sheet 17 is configured to convert light ejected from the diffusion plate 15 into planer light having a uniform and predetermined brightness (e.g., 10000 cd/m²) or more and allows the planer light to enter the liquid crystal panel 2 as illumination light. Alternatively, an optical member, such as a diffusion sheet for adjusting the viewing angle of the liquid crystal panel 2, may be laminated appropriately on the upper side (display surface side) of the liquid crystal panel 2, for example.

At the center of the left end side in FIG. 1 which is to be the upper side during the actual use of the liquid crystal display device 1, a protrusion sticking out towards the left side in the drawing is formed on the optical sheet 17, for example. And only the protrusion of the optical sheet 17 is interposed between the inner surface of the frame 13 and the pressure member 16 via an elastic material 18, so that the optical sheet 17 is incorporated in the backlight device 3 in an expandable state. Thus, even when expansion (plastic) deformation occurs to the optical sheet 17 due to the influence of heat such as heat generated by the cold cathode lamps 20a to 21h, etc., free expansion deformation mainly in the protrusion becomes possible, whereby the occurrence of wrinkles, bending, etc., to the optical sheet 17 can be minimized. As a result, in the liquid crystal display device 1, deterioration in the display quality of the display surface of the liquid crystal panel 2, such as unevenness in brightness resulting from the bending and the like of the optical sheet 17, can be minimized.

The reflecting sheet 19 is formed of for example, a film made of metal having a high light reflectivity, such as aluminum or silver, and having a thickness of about 0.2 to 0.5 mm, and it functions as a reflector for reflecting light from the cold cathode fluorescent lamps 20a to 20h towards the diffusion plate 15. Consequently, in the backlight device 3, it is possible to increase the usage efficiency of light from the cold cathode fluorescent lamps 20a to 20h and the brightness of the light on the diffusion plate 15. It is to be noted that, in place of the metal film, a reflecting sheet material made of a synthetic resin may be used or the inner surface of the case 12 may be configured to function as a reflector by applying a coating, for example, a white coating having a high light reflectivity to the inner surface.

Straight fluorescent lamps are used for the cold cathode fluorescent lamps 20a to 20h. Electrode portions (not shown) provided at both ends of each fluorescent tube are supported outside the case 12. Further, the lamps used for the cold cathode fluorescent lamps 20a to 20h are thinned lamps with excellent light emission efficiency whose diameter is about 3.0 to 4.0 mm. The cold cathode fluorescent lamps 20a to 20h are held within the case 12 by a light source holder (not shown) while the distances from each of the cold cathode fluorescent lamps 20a to 20h to the diffusion plate 15 and to the reflecting sheet 19 are kept at predetermined distances. Furthermore, the cold cathode lamps 20a to 20h are placed so that their longitudinal direction is parallel to a direction perpendicular to the direction of gravity. As a result, mercury (vapor) charged in the cold cathode lamps 20a to 20h is prevented from leaning to one side in the longitudinal direction under the action of gravity, so that the life spans of the lamps have been improved significantly.

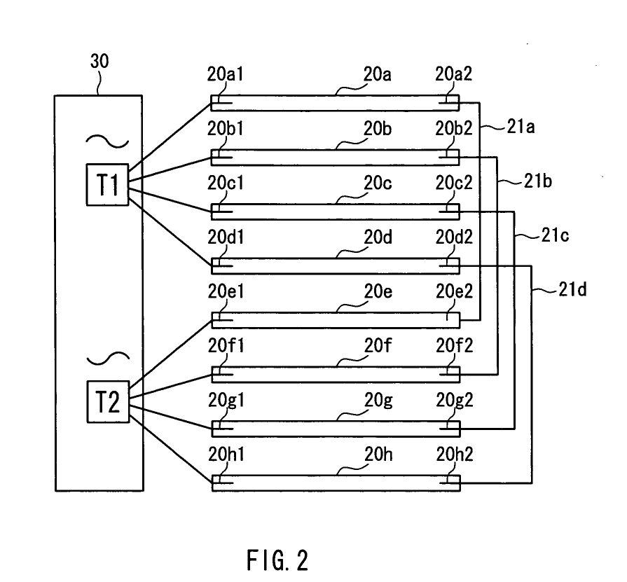

Next, a driving circuit for driving the cold cathode fluorescent lamps 20a to 20h as the light source lamps of the backlight device according to the present embodiment will be described with reference to FIG. 2.

FIG. 2 is a schematic block diagram showing a connection status of the cold cathode fluorescent lamps 20a to 20h and an inverter circuit 30 for generating voltages for driving the cold cathode fluorescent lamps 20a to 20h in the backlight device according to the present embodiment. It is assumed that FIG. 2 is a plan view showing the arrangement of the cold cathode fluorescent lamps in the backlight device from the display surface side of the liquid crystal display element as the display panel. That is, the vertical direction in FIG. 2 corresponds to the vertical direction of images that are displayed on the liquid crystal panel and the horizontal direction in FIG. 2 corresponds to the horizontal direction of images that are displayed on the liquid crystal panel.

Here, the only components peculiar to the inverter circuit 30 in the backlight device of the present embodiment are inverter transformers that supply boosted operating voltages to the cold cathode fluorescent lamps. Other circuit components, such as a detection circuit that detects lamp currents that actually flowed to the cold cathode fluorescent lamps, a feedback circuit and adjustment circuit that keep lamp currents constant and a stabilizing circuit that stabilizes discharges of the cold cathode fluorescent lamps and the operation of the inverter circuit itself, are no different from those that have been used conventionally in inverter circuits.

That is, the inverter circuit of the backlight device described in the present embodiment also includes a control portion for controlling the driving of the cold cathode fluorescent lamps and CCFL driving circuits provided for the respective cold cathode fluorescent lamps for lighting and driving the corresponding cold cathode fluorescent lamps on the basis of driving signals from the control portion. The values of lamp currents that actually flowed to the respective cold cathode fluorescent lamps are transmitted to the control portion from the lamp current detection circuit through the feedback circuit. The control portion maintains the brightness of the cold cathode fluorescent lamps at a desired value on the basis of brightness dimming signals inputted externally to the control portion for adjusting the brightness of the cold cathode fluorescent lamps and the fed-back lamp current values. Since techniques that have been used generally in inverter circuits can be used in their entirety for the circuit components other than the inverter transformers, the detail description thereof is omitted.

With regard to the inverter circuit 30 of the backlight device according to the present embodiment, voltages that are outputted respectively from the inverter transformers have opposite phases in waveform, as the waveforms showing the phases of output voltages of the inverter transformers indicate in FIG. 2. That is, the inverter circuit 30 includes a first inverter transformer T1 and a second inverter transformer T2 that have opposite phases to each other. As a method of forming the inverter transformers that have different phases, it is possible to use a conventionally known method such as setting the winding directions of coils of two transformers placed in parallel to be opposite to each other or inverting the connection direction of a primary or secondary coil of inverter transformers.

Each of the cold cathode fluorescent lamps 20a to 20h includes a pair of electrodes at its both ends in the longitudinal direction. In FIG. 2, first electrodes 20a1 to 20h1 of the cold cathode fluorescent lamps 20a to 20h are provided at the left ends dose to the inverter circuit 30 and second electrodes 20a2 to 20h2 of the cold cathode fluorescent lamps 20a to 20h are provided at the right ends in the drawing farther from the inverter circuit 30.

The first electrodes 20a1 to 20d1 of the four cold cathode fluorescent lamps 20a to 20d shown on the upper side of FIG. 2 are connected to the first inverter transformer T1 of the inverter circuit 30. Further, the first electrodes 20e1 to 20h1 of the four cold cathode fluorescent lamps 20e to 20h shown on the lower side of FIG. 2 are connected to the second inverter transformer T2 of the inverter circuit 30. In other words, the four cold cathode fluorescent lamps 20a to 20d whose first electrodes are connected to the first inverter transformer T1 are arranged in sequence and form a first multi lamp array group, and the four cold cathode fluorescent lamps 20e to 20h whose first electrodes are connected to the second inverter transformer T2 are arranged in sequence and form a second multi lamp array group.

And as shown in FIG. 2, the second electrode 20a2 of the cold cathode fluorescent lamp 20a that constitutes the first multi lamp array group and the second electrode 20e2 of the cold cathode fluorescent lamp 20e that constitutes the second multi lamp array group are connected to each other through a connection line 21a, forming a pseudo U-shaped tube structure in which the cold cathode lamps 20a and 20e are connected to each other in series between the first inverter transformer T1 and the second inverter transformer T2 Similarly, the second electrode 20b2 of the cold cathode fluorescent lamp 20b that constitutes the first multi lamp array group and the second electrode 20f2 of the cold cathode fluorescent lamp 20f that constitutes the second multi lamp array group are connected to each other through a connection line 21b, the second electrode 20c2 of the cold cathode fluorescent lamp 20c that constitutes the first multi lamp array group and the second electrode 20g2 of the cold cathode fluorescent lamp 20g that constitutes the second multi lamp array group are connected to each other through a connection line 21c, and the second electrode 20d2 of the cold cathode fluorescent lamp 20d that constitutes the first multi lamp array group and the second electrode 20h2 of the cold cathode fluorescent lamp 20h that constitutes the second multi lamp array group are connected to each other through a connection line 21d, forming pseudo U-shape tube structures, respectively.

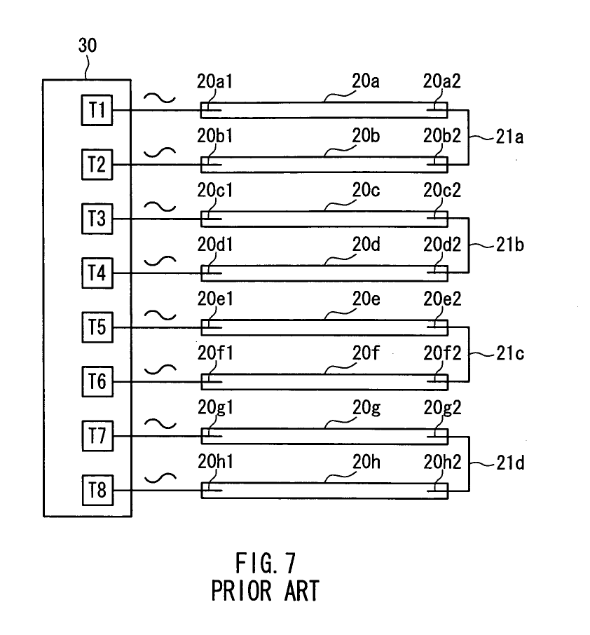

In the backlight device according to the present embodiment, the cold cathode fluorescent lamps 20a to 20h as the light source lamps are arranged in sequence so as to form the first multi lamp array group and the second multi lamp array group as described above. Thus, unlike the conventional pseudo U-shaped tube structure shown in FIG. 7, it is not necessary to place the first inverter transformer T1 and the second inverter transformer T2 of the inverter circuit 30 in an alternating sequence.

Therefore, it is possible to reduce the number of the inverter transformers to two from, for example, eight, which number required in the conventional backlight device shown in FIG. 7 for the eight cold cathode fluorescent lamps. Furthermore, in terms of ensuring the insulation between adjacent inverter transformers that have different polarities, it is also possible to reduce the number of locations that need to be insulated to one from seven among the eight inverter transformers. As a result, the configuration of the inverter circuit can be significantly simplified, and cost cutting and a reduction in the size of the inverter circuit itself can be achieved.

Furthermore, it is possible to restrict the phases of outputs from the inverter transformers to the corresponding multi lamp array groups. Thus, for example, when using separate circuit boards for the respective inverter circuits, the voltage polarity within a single board can be set the same. Consequently, there is no need to take measures to insulate between circuit elements within each circuit board, so that the configuration of each circuit board can be simplified and the circuit boards themselves can be downsized.

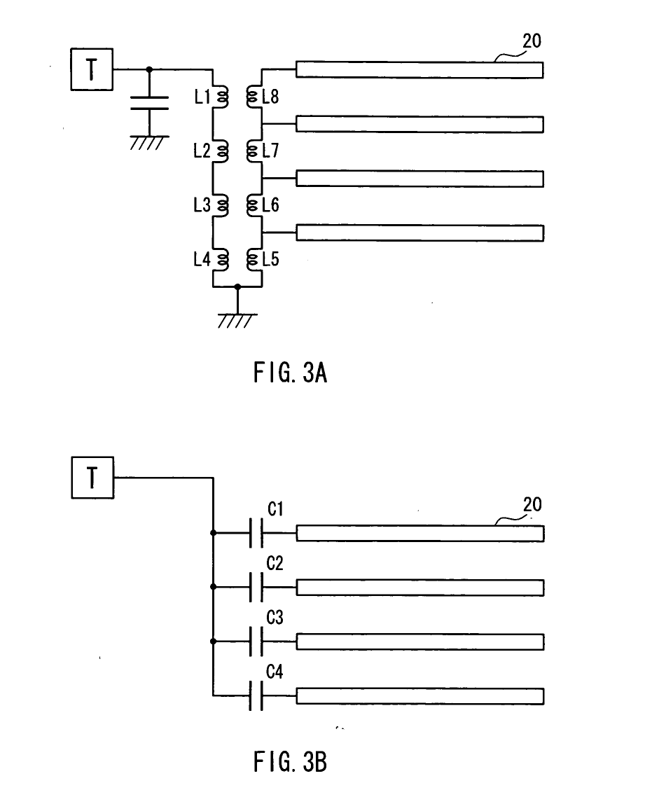

When distributing driving voltages to a plurality of cold cathode fluorescent lamps from a single inverter transformer, outputs from each inverter transformer may be distributed with the use of distributors. The method will be described with reference to FIG. 3.

FIGS. 3A and 3B are schematic circuit diagrams showing specific configurations for distributing an output from an inverter transformer T to a plurality of cold cathode fluorescent lamps 20. FIG. 3A shows a case where coils are used as the distributors and FIG. 3B shows a case where capacitors are used as the distributors.

As shown in FIG. 3A, in the case of using coils as the distributors, four coils L1 L2, L3 and LA having the same conductance are connected to each other in series between the output terminal of the inverter transformer T and the ground. Four other coils L5, L6, L7 and L8 having the same conductance which pair up with the coils L1, L2, L3 and L4 are provided, and the connection terminal portions of the four other coils may be respectively connected to the first electrodes of the four cold cathode fluorescent lamps 20.

When using capacitors as the distributors as shown in FIG. 3B, four capacitors C1, C2, C3 and C4 having the same capacitance are connected to the output terminal of the inverter transformer T in series, and the first electrodes of the cold cathode fluorescent lamps 20 may be connected to the four capacitors.

By so doing, in the backlight device according to the present embodiment, it is possible to simplify the configuration of the inverter circuit while adopting a lamp arrangement with a pseudo U-shaped tube structure where the second electrodes not in connection with the inverter circuit can be connected to each other simply.

Next, an applied example of the display device according to Embodiment 1 of the present invention will be described.

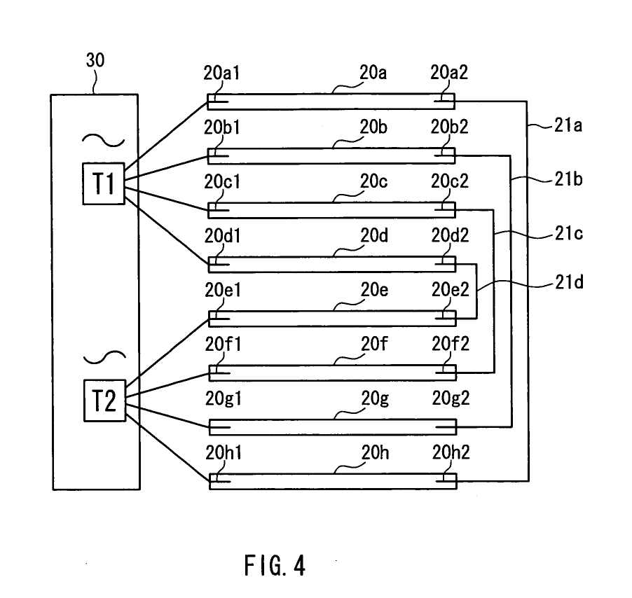

FIG. 4 is a schematic diagram showing a circuit configuration of cold cathode fluorescent lamps and an inverter circuit for driving the cold cathode fluorescent lamps in a backlight device used in the liquid crystal display device according to the present embodiment. The drawing corresponds to FIG. 2 in which the backlight device according to Embodiment 1 described above is shown.

The only difference between the applied example of the backlight device according to the present embodiment and the backlight device according to Embodiment 1 is the connection relationship between the second electrodes 20a2 to 20h2 of the cold cathode fluorescent lamps 20a to 20h at the time of connecting the eight cold cathode fluorescent lamps to each other to form pseudo U shapes. Thus, description of other components that are the same as those of the above-described backlight device according to Embodiment 1 will not be repeated.

As shown in FIG. 4, in the applied example of the backlight device according to the present embodiment, the cold cathode fluorescent lamps that are connected to each other to form pseudo U shapes have different combinations. The second electrode 20a2 of the cold cathode fluorescent lamp 20a and the second electrode 20h2 of the cold cathode fluorescent lamp 20h are connected to each other in series through the connection line 21a, the second electrode 20b2 of the cold cathode fluorescent lamp 20b and the second electrode 20g2 of the cold cathode fluorescent lamp 20g are connected to each other in series through the connection line 21b, the second electrode 20c2 of the cold cathode fluorescent lamp 20c and the second electrode 20f2 of the cold cathode fluorescent lamp 20f are connected to each other in series through the connection line 21c, and the second electrode 20d2 of the cold cathode fluorescent lamp 20d and the second electrode 20e2 of the cold cathode fluorescent lamp 20e are connected to each other in series through the connection line 21d.

Also in this applied example, similarly to the above-described configuration shown in FIG. 2, the four cold cathode fluorescent lamps, 20a, 20b, 20c and 20d, form the first multi lamp array group and the four cold cathode fluorescent lamps, 20e, 20f, 20g and 20h, form the second multi lamp array group.

In the present embodiment, even when connections of the second electrodes of the cold cathode fluorescent lamps are changed in this way, the effects of the backlight device of the present invention can still be achieved. In addition to the combinations shown in FIGS. 2 and 4, it is needless to say that the same effects can still be achieved by connecting any of the second electrodes of the cold cathode fluorescent lamps of the first multi lamp array group to any of the second electrodes of the cold cathode fluorescent lamps of the second multi lamp array group.

In the present embodiment, since driving voltages that have opposite phases are applied respectively to the first electrodes of the cold cathode fluorescent lamps of the first multi lamp array group and the first electrodes of the cold cathode fluorescent lamps of the second multi lamp array group, the voltages at the connection lines that connect the second electrodes of the cold cathode fluorescent lamps to each other as middle portions are always 0V in principle. Therefore, the connection lines as the connection portions between the second electrodes may be grounded actively or they may not be grounded.

Further, since the connection portions between the second electrodes of the corresponding cold cathode fluorescent lamps are always 0V in principle, there is no need to take extra care in electrically routing the connection portions between the second electrodes. Specifically, so long as the second electrodes of the corresponding cold cathode fluorescent lamps can be connected to each other electrically, there is no limitation in specific means. Therefore, the second electrodes may be connected to each other with ease and certainty, normally, by placing the connectors for connecting the second electrodes of the corresponding cold cathode fluorescent lamps to each other on sockets for holding the ends of the cold cathode fluorescent lamps in the backlight device and bringing them into electric conduction.

### Embodiment 2

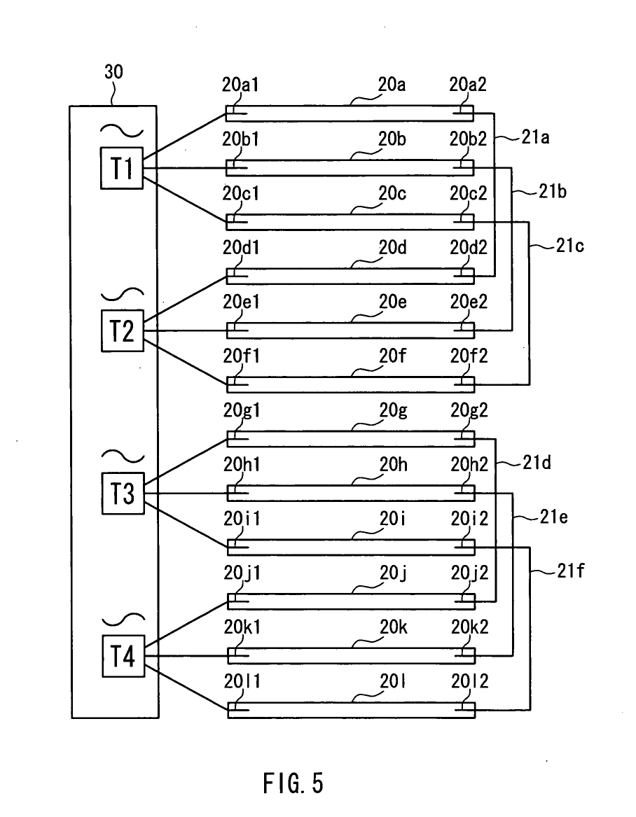

Next, a backlight device used in a display device will be described as Embodiment 2 of the display device according to the present invention with reference to FIG. 5.

FIG. 5 is a schematic diagram showing a connection state of cold cathode fluorescent lamps and an inverter circuit in a backlight device used in a display device according to Embodiment 2 of the present invention.

The backlight device according to the present embodiment uses twelve cold cathode fluorescent lamps 20, and a total of four multi lamp array groups, each of which includes three cold cathode fluorescent lamps 20, are formed. Specifically, three cold cathode fluorescent lamps 20a to 20c whose first electrodes 20a1 to 20c1 are connected to a first inverter transformer T1 of an inverter circuit 30 form a first multi lamp array group, and three cold cathode fluorescent lamps 20d to 20f whose first electrodes 20d1 to 20f1 are connected to a second inverter transformer T2 of the inverter circuit 30 having an opposite phase to the first inverter circuit T1 form a second multi lamp array group. Furthermore, three cold cathode fluorescent lamps 20g to 20i whose first electrodes 20g1 to 20i1 are connected to a third inverter transformer T3 of the inverter circuit 30 having the same phase as the inverter transformer T1 form a third multi lamp array group that can be considered as a second first multi lamp array group. Also three cold cathode fluorescent lamps 20j to 20l whose first electrodes 20j1 to 20l1 are connected to a fourth inverter transformer T4 of the inverter circuit 30 having an opposite phase to the third inverter circuit T3 form a fourth multi lamp array group that can be considered as a second second multi lamp array group.

When a liquid crystal panel as the display element of the display device is large in size and the number of lamps as the light source that are required by the backlight device is large as in the above case, a plurality of the first multi lamp array groups and a plurality of the second multi lamp array groups to which driving voltages having the same phase are applied respectively to the first electrodes may be provided in alternate order.

By so doing, even when driving voltages need to be supplied to the number of lamps that exceeds a capacity of distributing outputs only from a single inverter transformer, it is possible to simplify the configuration of the inverter circuit while using the pseudo U-shaped tube method.

It is needless to say that any of the examples of connecting the second electrodes to each other in the lamp arrangements described in Embodiment 1 can be used to connect to the second electrodes of the cold cathode fluorescent lamps of the first multi lamp array group and the second electrodes of the corresponding cold cathode fluorescent lamps of the second multi lamp array group to each other in the present embodiment.

In each embodiment of the present invention, the case of using cold cathode fluorescent lamps as the light source lamps have been described as an example. However, the present invention is not limited thereto and hot cathode fluorescent tubes and other lamps can also be used.

Further, the lamps are not limited to straight lamps that are circular in cross section, and it is also possible to use flat lamps that are ellipse or track in cross section and have a light-emitting surface broadened to improve the light-emission efficiency.

Furthermore, although the case of using an active matrix liquid crystal panel as the liquid crystal panel as the display portion has been described as an example, the display portion of the display device of the present invention is not limited thereto and other type of liquid crystal panels such as a simple matrix liquid crystal panel can also be used.

### INDUSTRIAL APPLICABILITY

The present invention is industrially applicable as a backlight device having a simplified driving voltage supply structure to lamps and a display device including the backlight device as a planar light source.

1. A backlight device comprising a plurality of lamps arranged in series, an inverter circuit for generating, from input voltages, voltages for driving the lamps and a light-emitting surface for emitting light from the lamps towards outside,
wherein the lamps each include first and second electrodes at both ends thereof in a longitudinal direction,
the inverter circuit includes first and second inverter transformers that have opposite phases to each other,
among the lamps, those with the first electrodes being connected to the first inverter transformer are arranged in sequence and form a first multi lamp array group, and those with the first electrodes being connected to the second inverter transformer are arranged in sequence and form a second multi lamp array group, and
the second electrodes of the lamps of the first multi lamp array group are connected to any of the second electrodes of the lamps of the second multi lamp array group.

2. The backlight device according to claim 1, wherein at least the number of the first multi lamp array group or the second multi lamp array group formed in the backlight device is more than one.

3. The backlight device according to claim 2, wherein two or more of the first multi lamp array groups and of the second multi lamp array groups are arranged in alternate order.

4. The backlight device according to claim 1, wherein the lamps are cold cathode fluorescent lamps.

5. The backlight device according to claim 4, wherein the cold cathode fluorescent lamps are straight fluorescent tubes that are circular in cross section.

6. The backlight device according to claim 1, further comprising a coil for distributing an output of the inverter transformers to the plurality of lamps of the multi lamp array groups.

7. The backlight device according to claim 1, further comprising a capacitor for distributing an output of the inverter transformers to the plurality of lamps of the multi lamp array groups.

8. A display device comprising:
a display portion; and
the backlight device according to claim 1, wherein the display portion is irradiated with light from the backlight device.
